(19) United States
(12) Patent Application Publication
(10) Pub. No.: US 2025/0346487 A1
(43) Pub. Date: Nov. 13, 2025

(54) DECOMPOSING A FLOWING FEEDSTOCK

(71) Applicant: EKONA POWER INC., Burnaby (CA)

(72) Inventors: Timothy Scott COLEMAN, Port Moody (CA); David Aaron LEBOE, Vancouver (CA); Milo DEL BIGIO, Vancouver (CA)

(21) Appl. No.: 19/202,773

(22) Filed: May 8, 2025

Related U.S. Application Data
(60) Provisional application No. 63/645,396, filed on May 10, 2024.
(60) Provisional application No. 63/664,914, filed on Jun. 27, 2024.

(51) Int. Cl. C01B 3/24; C01B 3/50

(52) U.S. Cl. CPC C01B 3/24; C01B 3/508; C01B 2203/0811; C01B 2203/1241; C01B 2203/1276; C01B 2203/145; C01B 2203/1614; C01B 2203/169

(57) ABSTRACT

A method of decomposing a pre-heated feedstock includes flowing a stream of the pre-heated feedstock and injecting an oxidant into the flowing stream of pre-heated feedstock. The oxidant mixes with the pre-heated feedstock and, in response to the mixing, at least a first portion of the pre-heated feedstock auto-ignites and causes at least a second portion of the pre-heated feedstock to decompose into one or more products by pyrolysis.

### CROSS-REFERENCE TO RELATED APPLICATION

This application claims priority from U.S. Provisional Patent Application Ser. No. 63/645,396 filed on May 10, 2024 and U.S. Provisional Patent Application Ser. No. 63/664,914 filed on Jun. 27, 2024, the entire disclosures of which are part of the disclosure of the present application and are hereby incorporated by reference in their entireties.

### FIELD

The present disclosure relates to thermal pyrolysis and in particular to methods and systems for decomposing a flowing feedstock.

### BACKGROUND

Thermal pyrolysis is a method by which a feedstock gas, such as a hydrocarbon, is decomposed without oxygen into its constituent elements (in the case of a hydrocarbon, carbon and hydrogen). The decomposition is triggered by sufficiently raising the temperature of the feedstock gas to a point at which the chemical bonds of the elements of the feedstock gas break down.

Such pyrolysis may be achieved, for example, by bringing the feedstock gas into thermal contact with a hot fluid. For instance, combustion product gases, formed as a result of combusting a combustible fuel, may be mixed with the feedstock gas. At high-enough temperatures, the mixing of the hot fluid with the feedstock gas, and the transfer of thermal energy from the hot fluid to the feedstock gas, is sufficient to cause the feedstock gas to break down and decompose.

One method of generating combustion products is to combust a combustible fuel-oxidant mixture in a combustion chamber connected to a reaction chamber in which is located the feedstock. Following combustion, the combustion products that are generated flow into the reaction chamber, mix with the feedstock, and trigger its decomposition.

Such combustion in an enclosed combustion chamber can result in very high temperatures and pressures. This increases the likelihood that the combustible mixture will detonate, further increasing pressure and driving potentially damaging shock waves into the reaction chamber which can compromise components such as injection nozzles and refractories lining the interior of the reaction chamber.

Furthermore, such an approach may result in lower-than-desired combustion energy being delivered to the reaction chamber. While this heat transfer can be reduced by increasing the temperature of the combustor to reduce the differential temperature between the combustor and the combustion products, this may trigger auto-ignition of the pre-mixed fuel and oxidant entering the combustion chamber. In order to avoid auto-ignition of the combustible mixture, the combustion chamber and internal components may be actively cooled. However, this cooling load extracts significant heat and energy otherwise intended to drive the pyrolysis reaction, and represents a significant energy loss.

### SUMMARY

According to a first aspect of the disclosure, there is provided a method of decomposing a pre-heated feedstock, comprising: flowing a stream of the pre-heated feedstock; injecting an oxidant into the flowing stream of pre-heated feedstock, wherein the oxidant mixes with the pre-heated feedstock and wherein, in response to the mixing, at least a first portion of the pre-heated feedstock auto-ignites and causes at least a second portion of the pre-heated feedstock to decompose into one or more products by pyrolysis.

Flowing the stream of the pre-heated feedstock may comprise: pre-heating a feedstock to within a range of 500 degrees C. to 1,125 degrees C.; and flowing the stream of the pre-heated feedstock.

Injecting the oxidant may comprise injecting the oxidant into the flowing stream of pre-heated feedstock through one or more nozzles.

Flowing the stream of the pre-heated feedstock may comprise flowing the stream of the pre-heated feedstock along a conduit. The nozzles may extend through one or more walls of the conduit.

Mixing the oxidant with the pre-heated feedstock may comprise: injecting a first stream of the oxidant into the flowing stream of pre-heated feedstock; and injecting a second stream of the oxidant into the flowing stream of pre-heated feedstock, wherein the first and second streams intersect to improve mixing of the oxidant with the pre-heated feedstock.

Injecting the first stream of the oxidant may comprise injecting the first stream from a first fluid injector. Injecting the second stream of the oxidant may comprise injecting the second stream from a second fluid injector. The method may further comprise: injecting from the first fluid injector a third stream of the oxidant; and injecting from the second fluid injector a fourth stream of the oxidant that intersects with third stream to improve mixing of the oxidant with the pre-heated feedstock.

The method may further comprise: injecting from the first fluid injector a fifth stream of the oxidant; and injecting from the second fluid injector a sixth stream of the oxidant that intersects with the fifth stream to improve mixing of the oxidant with the pre-heated feedstock.

The method may further comprise: injecting a third stream of the oxidant into the flowing stream of pre-heated feedstock; and injecting a fourth stream of the oxidant into the flowing stream of pre-heated feedstock that intersects with the third stream and generates within the flowing stream of pre-heated feedstock a further stream of the oxidant that intersects with a stream of the oxidant generated as a result of the first stream intersecting with the second stream.

Injecting the first stream of the oxidant may comprise injecting the first stream from a first fluid injector. Injecting the second stream of the oxidant may comprise injecting the second stream from a second fluid injector offset from the first fluid injector, wherein, in response to the first and second streams intersecting one another, vorticity is introduced to at least one of the first and second streams to improve mixing of the oxidant with the pre-heated feedstock.

The pre-heated feedstock may comprise a hydrocarbon.

The hydrocarbon may be methane or natural gas.

The oxidant may comprise pure oxygen.

Injecting the oxidant may comprise pulsing the injection of the oxidant into the flowing stream of pre-heated feedstock.

The method may further comprise using a flow restriction downstream of a location at which the oxidant is injected in order to control a pressure pulse generated by the pulsing of the oxidant injection.

Injecting the oxidant into the flowing stream of pre-heated feedstock may comprise: injecting a fuel with the oxidant into the flowing stream of pre-heated feedstock, wherein, in response to the fuel mixing with the pre-heated feedstock in the presence of the oxidant, the fuel auto-ignites and generates one or more combustion products that mix with the pre-heated feedstock and cause the pre-heated feedstock to decompose into one or more reaction products.

Injecting the fuel and the oxidant may comprise: mixing the fuel with the oxidant to form a combustible mixture; and injecting the combustible mixture into the flowing stream of pre-heated feedstock.

Injecting the fuel and the oxidant may comprise simultaneously injecting the fuel and the oxidant into the flowing stream of pre-heated feedstock.

Simultaneously injecting the fuel and the oxidant into the flowing stream of pre-heated feedstock may result in the fuel and oxidant mixing together in the flowing stream of pre-heated feedstock.

The fuel may have a composition that is different to the composition of the feedstock.

The fuel may comprise one or any combination of: hydrogen; CO; CO₂; and a hydrocarbon.

Injecting the fuel and the oxidant may comprise injecting the fuel and the oxidant through a nozzle that extends into a reaction chamber along which the stream of pre-heated feedstock is flowing.

The method may further comprise: combusting a fuel and an oxidant in a burner located upstream of a location where the oxidant is injected into the flowing stream of pre-heated feedstock, thereby producing combustion products; and mixing the combustion products with the flowing stream of pre-heated feedstock to drive decomposition of the pre-heated feedstock by pyrolysis.

Flowing the stream of pre-heated feedstock may comprise flowing the stream of pre-heated feedstock through a choke. The method may further comprise flowing the combustion products through the choke.

Flowing the stream of pre-heated feedstock may comprise flowing the pre-heated feedstock into the choke in a first direction after which the stream of pre-heated feedstock flows out of the choke in a second direction perpendicular to the first direction.

The fuel and the oxidant may be provided to the burner in a lean fuel-oxidant mixture such that residual oxidant mixes with the pre-heated feedstock and causes some of the pre-heated feedstock to auto-ignite and generate further combustion products.

The method may further comprise quenching the decomposition of the pre-heated feedstock at a location downstream of where the oxidant is injected into the flowing feedstock.

The method may use a steady-flow reactor.

According to a further aspect of the disclosure, there is provided a feedstock reactor comprising: a reaction zone; valving and one or more compressors for allowing a pre-heated feedstock to flow along the reaction zone, and for allowing an oxidant to flow into the reaction zone; and one or more controllers comprising circuitry and configured to: control the valving and the one or more compressors to flow a stream of the pre-heated feedstock along the reaction zone; and control the valving and the one or more compressors to inject an oxidant into the flowing stream of pre-heated feedstock, wherein the oxidant mixes with the pre-heated feedstock, and wherein, in response to the mixing, at least a first portion of the pre-heated feedstock auto-ignites causes at least a second portion of the pre-heated feedstock to decompose into one or more products.

The valving and the one or more compressors may be further configured to allow a fuel to flow into the reaction zone. The one or more controllers may be further configured to: control the valving and the one or more compressors, when with the pre-heated feedstock is flowing along the reaction zone, to inject the fuel and the oxidant into the reaction zone such that the fuel and the oxidant mix with the pre-heated feedstock, wherein, in response to the fuel mixing with the pre-heated feedstock in the presence of the oxidant, the fuel auto-ignites and generates one or more combustion products that mix with the pre-heated feedstock and cause the pre-heated feedstock to decompose into one or more reaction products.

This summary does not necessarily describe the entire scope of all aspects. Other aspects, features, and advantages will be apparent to those of ordinary skill in the art upon review of the following description of specific embodiments.

### DRAWINGS

FIG. 1 is a schematic diagram of a feedstock reactor being used to decompose a flowing feedstock, according to an embodiment of the disclosure;

FIG. 2A is a schematic side-on view of a system for mixing an oxidant with a feedstock, in a loading stage, according to an embodiment of the disclosure;

FIG. 2B is a schematic end-on view of the system of FIG. 2A;

FIG. 2C is a schematic side-on view of the system of FIG. 2A in a mixing stage, according to an embodiment of the disclosure;

FIG. 2D is a schematic end-on view of the system of FIG. 2C;

FIG. 3A is another schematic side-on view of a system for mixing an oxidant with a feedstock, with angled fluid injectors, according to an embodiment of the disclosure;

FIG. 3B is a schematic end-on view of the system of FIG. 3A;

FIG. 4A is a schematic side-on view of a system for mixing an oxidant with a feedstock, according to another embodiment of the disclosure;

FIG. 4B is a schematic end-on view of the system of FIG. 4A;

FIG. 5 shows schematic side-on views of systems for mixing an oxidant with a feedstock, according to embodiments of the disclosure;

FIG. 6 is a schematic diagram of a feedstock reactor being used to decompose a pre-heated feedstock, according to an embodiment of the disclosure;

FIGS. 7A and 7B are schematic diagrams of injectors being used to deliver a fuel and an oxidant to a reaction chamber loaded with a pre-heated feedstock, according to an embodiment of the disclosure; and

FIG. 8 is a schematic diagram of a steady-flow reactor according to an embodiment of the disclosure.

### DETAILED DESCRIPTION

The present disclosure seeks to provide methods and systems for decomposing a flowing feedstock. While various embodiments of the disclosure are described below, the disclosure is not limited to these embodiments, and variations of these embodiments may well fall within the scope of the disclosure which is to be limited only by the appended claims.

Throughout this disclosure, unless otherwise specified, a reaction chamber should be interpreted as encompassing any volume or zone within which pyrolysis of a feedstock is intended to occur. Therefore, a reaction chamber includes the reaction chamber of a steady-flow reactor and refers to the zone or volume along which feedstock is continuously flowed. In addition, a reaction chamber includes the reaction chamber of a constant-pressure reactor and refers to the zone or volume contained by the sealed pressure vessel of such a reactor.

According to embodiments of the disclosure, a pre-heated feedstock is decomposed by flowing a stream of the pre-heated feedstock and injecting an oxidant into the flowing stream of pre-heated feedstock. The oxidant mixes with the pre-heated feedstock and, in response to the mixing, a first portion of the pre-heated feedstock auto-ignites and causes a second portion of the pre-heated feedstock to decompose into one or more products.

Therefore, instead of using discrete combustors to generate combustion products that are then injected into a reaction chamber in which is located the feedstock, an oxidant may be sprayed or otherwise injected into a moving stream of pre-heated feedstock. The oxidant may be injected through injector nozzles placed in an opposed configuration to allow the streams from opposed nozzles to intersect one-another to improve mixing of the oxidant with the feedstock. In order to inject the oxidant into the stream of flowing feedstock, automotive-style direct injectors using pressures of up to 350 bar may be used.

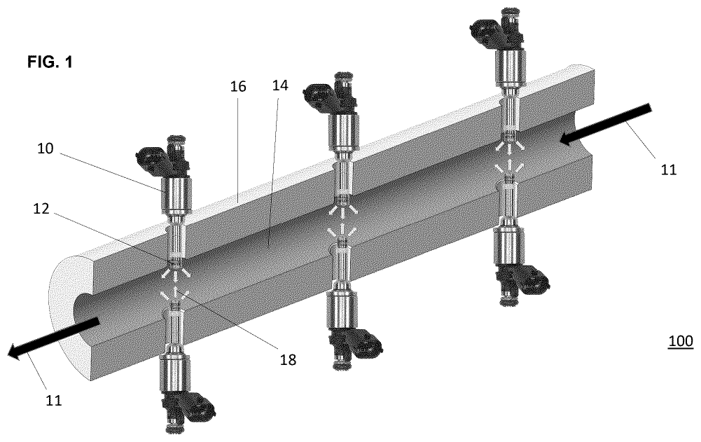

Turning to FIG. 1, there is shown an embodiment of a feedstock reactor 100 used to decompose a flowing feedstock, according to an embodiment of the disclosure.

Reactor 100 includes a reaction chamber 14, in the form of an elongate conduit, connected to multiple oxidant injectors 10. Each oxidant injector 10 includes a nozzle 12 extending through a wall 16 of reaction chamber 14 and extending into reaction chamber 14. Oxidant injectors 10 are configured to inject an oxidant, such as pure oxygen or air, into reaction chamber 14. In the further discussion below, the oxidant is assumed to be pure oxygen (O₂). A pre-heated feedstock (such as a hydrocarbon, for example methane) is flowed along reaction chamber 14, as indicated by the arrows 11. Generally, the feedstock is heated to a temperature sufficient such that the feedstock may auto-ignite when in contact with the oxidant. According to some embodiments, the feedstock is pre-heated to at least 500 degrees, C, at least 700 degrees C., at least 760 degrees C., at least 900 degrees C., at least 1,025 degrees C., or at least 1,125 degrees C., depending on the gas composition.

As the feedstock flows along reaction chamber 14, oxidant injectors 10 inject or otherwise introduce under pressure oxygen into the flow of feedstock, as shown by arrows 18. In response to the oxygen mixing with the pre-heated feedstock, a portion of the feedstock auto-ignites. Thermal energy is then transferred to another portion of the feedstock (i.e., feedstock that has not combusted), increasing the temperature of this unreacted feedstock sufficiently to drive decomposition or pyrolysis of the feedstock. In the case of methane, for example, the decomposition takes the following form:

CH₄+energy→C+2H₂

The pyrolysis reaction generates reaction products that may be extracted from reaction chamber 14. The reaction products may comprise one or more of hydrogen, nitrogen, and carbon.

Advantageously, the rates of injection of the oxygen can be optimized to mitigate the risk of detonation, since ignition of the feedstock can be more tightly controlled.

According to some embodiments, the feedstock may comprise methane, the oxidant may be air, and the temperature required for auto-ignition of the feedstock may be at least 850 K (at 1 bar).

According to some embodiments, the feedstock may comprise hydrogen, the oxidant may be air, and the temperature required for auto-ignition of the feedstock may be at least 770 K (at 1 bar).

According to some embodiments, the feedstock may comprise carbon monoxide, the oxidant may be air, and the temperature required for auto-ignition of the feedstock may be at least 880 K (at 1 bar).

According to various embodiments, improved mixing of the oxidant with the feedstock may be achieved by orienting the oxidant injectors to result in more uniform distribution of the oxidant throughout the feedstock, as described in further detail below. For instance, the injectors may be opposed or slightly offset relative to one another such that their respective streams of oxidant that are injected into the reaction chamber intersect and generate one or more additional streams within the reaction chamber. This may result in improved mixing of the feedstock and oxidant. Various examples of such mixing strategies are described in further detail below.

According to some embodiments, assuming a cylindrical reaction chamber, a pair of oxidant injectors (or simply “oxygen injectors” in that case that 02 is the oxidant) may be diametrically opposed from one another. Each oxidant injector includes one or more orifices (e.g. restrictors, nozzles, distributers, pathways, or other fluid flow channels) for directing the oxygen into the reaction chamber. Each orifice defines a respective injection direction into the reaction chamber. The injection direction of an orifice of the first oxidant injector intersects the injection direction of an orifice of the second oxidant injector.

According to some embodiments, the first and second oxidant injectors do not need to be diametrically opposed from one another but may be oriented relative to the longitudinal axis of the reaction chamber such that the injection direction of an orifice of the first oxidant injector intersects the injection direction of an orifice of the second oxidant injector.

Because of the intersection of the first and second injection directions, the first stream of oxygen collides with or otherwise impinges the second steam of oxygen. The impingement of the first and second streams of oxygen causes the directions of flow of the first and second streams to change from the first and second injection directions. The changing directions of flow of the first and second streams may cause improved mixing of the first and second streams of oxygen with the feedstock.

It shall be understood that, in order for the first and second streams to impinge one another, the first and second streams should generally be injected into the reaction chamber with sufficient momentum such that the first and second streams reach one another and thereby impinge one another.

According to some embodiments, the injection directions define, relative to an interior wall of the reaction chamber, an angle in the range of 59-909. Consequently, the orifices may be oriented such that the first and second injection directions may intersect at an angle of about 1809, or in some cases less than 1809. According to some embodiments, the injection directions may intersect at an angle between about 10 degrees and about 180 degrees, and more particularly about 160 degrees. For example, according to some embodiments, the first and second injection directions may define, relative to an interior wall of the reaction chamber, angles of about 80 degrees, and may intersect one another at an angle of about 160 degrees.

When injected into the reaction chamber, the streams of oxygen will generally adopt a cone-like shape as they expand outwardly after exiting the orifices. Therefore, due to the cone-like expansion of the stream, the stream will advance in many different directions, but the general direction of flow of the stream (i.e. the principal direction of flow) may be considered to be the “injection direction” as used herein. The injection direction may also be considered to be the direction along which the orifice points or is oriented. For example, the injection direction may be considered to be along an axis passing perpendicularly through a center of the orifice.

Furthermore, throughout this disclosure, when reference is made to a first injection direction intersecting a second injection direction, this should be interpreted as meaning that the stream of oxidant travelling along the first injection direction at least partially, if not fully, impinges the stream of oxidant travelling along the second injection direction. Therefore, while there may not be a full head-on collision between the two streams, at least some of the stream travelling along the first injection direction will impinge at least some of the stream travelling along the second injection direction, in part because of the respective cone-like expansions of the streams.

In this context, and according to some embodiments, the first oxygen injector may be slightly offset relative to the second oxygen injector so as to deliberately cause the principal directions of flow of the first and second streams to be offset from one another. In this case, while the first and second streams will not collide head-on, the first and second streams will still impinge each other due to the cone-like expansions of the streams as they are injected into the reaction chamber.

By offsetting the first and second oxygen injectors such that they are not precisely diametrically opposed from one another, the non-direct impingement of the first stream with the second stream may induce vorticity in the first stream, the second stream, and/or the further stream that is generated as a result of the impingement of the first and second streams. Such vorticity or otherwise turbulent flow may facilitate the mixing of the oxygen with the feedstock.

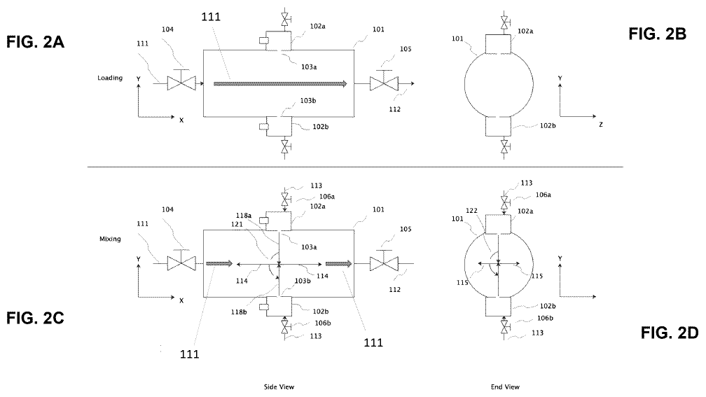

Turning to FIGS. 2A-2D, there is shown a first embodiment of a reactor that may be used for mixing oxygen (or, more generally, any oxidant) with a feedstock. The reactor includes two oxygen injectors 102a, 102b mounted onto a cylindrical reaction chamber 101. Oxygen injectors 102a, 102b are fluidly connected to reaction chamber 101 via orifices 103a, 103b. According to some embodiments, orifices 103a, 103b are permanently open. According to other embodiments, orifices 103a, 103b may be open or closed (using, for example, suitable valves under control of a controller, such as a computer or the like). Oxygen injectors 102a, 102b are oriented such that orifices 103a, 103b are aligned in the X and Z directions. In particular, oxygen injectors 102a, 102b (and, by extension, orifices 103a, 103b) are diametrically opposed from one another and relative to the longitudinal axis of reaction chamber 101.

Feedstock 111 is continuously flowed through reaction chamber 101 via an inlet valve 104 and an outlet valve 105. The positions of inlet valve 104 and outlet valve 105 are not necessarily as shown in the drawings. Oxygen 113 is then introduced under pressure into oxygen injectors 102a, 102b via secondary valves 106a, 106b. According to other embodiments, oxygen 113 may be introduced into oxygen injectors 102a, 102b before or during the flowing of feedstock 111 into reaction chamber 101. In order to initiate mixing, orifices 103a, 103b are opened, resulting in streams of oxygen 113 passing through orifices 103a, 103b and travelling into reaction chamber 101 along injection directions 118a and 118b defined by orifices 103a, 103b. The streams of oxygen 113 impinge on each other centrally within reaction chamber 101. The impingement of the streams of oxygen 113 causes their directions of flow to change, thereby allowing the streams of oxygen 113 to better mix with feedstock 111.

For example, as can be seen in FIGS. 2C and 2D, the streams of oxygen 113 mix with feedstock 111 along at least the X direction 114 and the Z direction 115, in a generally circular fashion. The angle 121 of the stream originating from orifice 103a as it enters reaction chamber 101, relative to the stream originating from orifice 103b as it enters reaction chamber 101, in the X-Y plane, is 180 degrees. The angle 122 of the stream originating from orifice 103a as it enters reaction chamber 101, relative to the stream originating from orifice 103b as it enters reaction chamber 101, in the Y-Z plane, is 180 degrees.

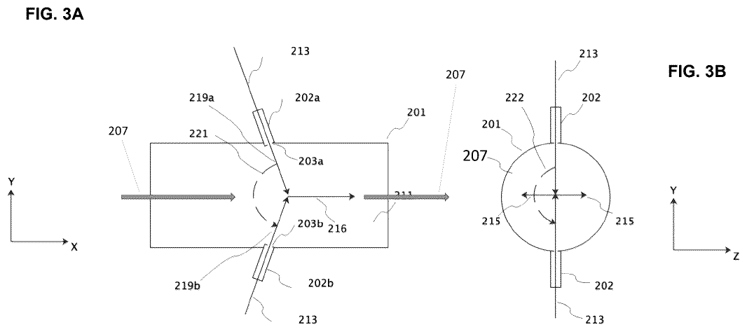

Turning to FIGS. 3A and 3B, there is shown another embodiment of a reactor that may be used for mixing oxygen (or, more generally, any oxidant) with a feedstock. The reactor includes two oxygen injectors 202a, 202b mounted onto a cylindrical reaction chamber 201. Oxygen injectors 202a, 202b are fluidly connected to reaction chamber 201 via orifices 203a, 203b which may be open or closed (using, for example, suitable valves) depending on whether or not the mixing stage has begun. While oxygen injectors 202a, 202b are diametrically opposed to one another, oxygen injectors 202a, 202b are oriented relative to the longitudinal axis of reaction chamber 201 such that orifices 203a, 203b are oriented at a non-normal angle relative to the longitudinal axis of reaction chamber 201, as described in further detail below.

Feedstock 207 is continuously flowed through reaction chamber 201 via an inlet valve and an outlet valve (the valves are not shown). During the mixing stage, streams of oxygen 213 pass through orifices 203a, 203b and travel into reaction chamber 201 along injection directions 219a and 219b defined by orifices 203a, 203b. The streams of oxygen 213 impinge on each other within reaction chamber 201. The impingement of the streams of oxygen 213 causes their directions of flow to change, thereby allowing the streams of oxygen 213 to better mix with feedstock 207.

The angle 221 of the stream originating from orifice 203a as it enters reaction chamber 201, relative to the stream originating from orifice 203b as it enters reaction chamber 201, in the X-Y plane, is less than 180 degrees. The angle 222 of the stream originating from orifice 203a as it enters reaction chamber 201, relative to the stream originating from orifice 203b as it enters reaction chamber 201, in the Y-Z plane, is 180 degrees. The impingement of the streams of oxygen 213 causes their directions of flow to change, thereby allowing the streams of oxygen 213 to mix with feedstock 207. Specifically, the streams of oxygen 213 principally mix with feedstock 207 in one direction 216 in the X-Y plane, direction 216 being aligned with the longitudinal axis of reaction chamber 201. Furthermore, the streams of oxygen 213 principally mix with feedstock 207 in two directions 215 in the Y-Z plane, directions 215 being perpendicular to the longitudinal axis of reaction chamber 201.

The angles 221 and 222 may be adjusted by configuring oxygen injectors 202a, 202b such that orifices 203a, 203b are oriented at different angles relative to the longitudinal axis of reaction chamber 201.

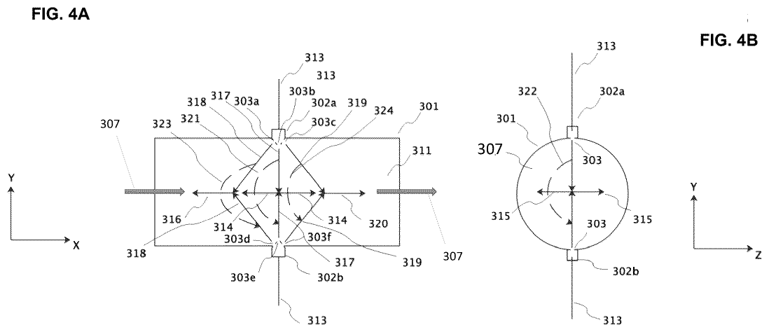

Turning to FIGS. 4A and 4B, there is shown another embodiment of a reactor that may be used for mixing oxygen (or, more generally, any oxidant) with a feedstock. The reactor includes two oxygen injectors 302a, 302b mounted onto a cylindrical reaction chamber 301. Oxygen injectors 302a, 302b are fluidly connected to reaction chamber 301 via orifices 303a, 303b, 303c, 303d, 303e, 303f which may be open or closed (using, for example, suitable valves) depending on whether or not the mixing stage has begun. While oxygen injectors 302a, 302b are diametrically opposed to one another, oxygen injectors 302a, 302b each include two orifices that are angled relative to the longitudinal axis of reaction chamber 301, and one orifice that is oriented perpendicular to the longitudinal axis of reaction chamber 301.

Feedstock 307 is continuously flowed through reaction chamber 301 via an inlet valve and an outlet valve (the valves are not shown). During the mixing stage of FIGS. 4A and 4B, streams 317, 318, 319 of oxygen 313 pass through orifices 303a, 303b, 303c and travel into reaction chamber 301 along the injection directions defined by orifices 303a, 303b, 303c. The streams 317, 318, 319 impinge on each other within reaction chamber 301. The impingement of the streams 317, 318, 319 causes their directions of flow to change, thereby allowing streams 317, 318, 319 to better mix with feedstock 307.

The angles 321 and 322 of stream 317 originating from the upper injector 302a as it enters reaction chamber 301, relative to stream 317 originating from the lower injector 302b as it enters reaction chamber 301, in the X-Y plane and in the Y-Z planes, are 180 degrees. The angle 323 of stream 318 originating from the upper injector 302a as it enters reaction chamber 301, relative to of stream 318 originating from the lower injector 302b as it enters reaction chamber 301, in the X-Y plane, is greater than 180 degrees. The angle 324 of stream 319 originating from the upper injector 302a as it enters reaction chamber 301, relative to stream 319 originating from the lower injector 302b as it enters reaction chamber 301, in the X-Y plane, is less than 180 degrees. The impingement of streams 317, 318, 319 causes their directions of flow to change, thereby allowing streams 317, 318, 319 to mix with feedstock 307. Specifically, streams 317 principally mix with feedstock 307 in two directions 314 in the X-Y plane, direction 314 being parallel to the longitudinal axis of reaction chamber 301. Furthermore, streams 318 principally mix with feedstock 307 in one direction 316 in the X-Y plane, and streams 319 principally mix with feedstock 307 in one direction 320 in the X-Y plane, directions 316 and 320 being parallel to the longitudinal axis of reaction chamber 301. Further still, streams 317, 318, 319 principally mix with feedstock 307 in two directions 315 in the Y-Z plane, directions 315 being perpendicular to the longitudinal axis of reaction chamber 301. Generally, streams 314, 316, and 320 adopt a generally circular shape.

According to some embodiments, additional oxygen streams can be added to those in FIGS. 4A and 4B (for example, by adding further orifices to oxygen injectors 302a, 302b) to optimize the mixing between oxygen 313 and feedstock 307.

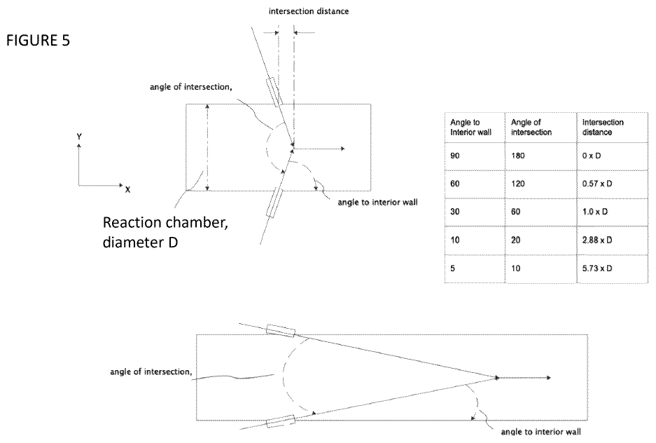

According to some embodiments (as can be seen for instance in FIG. 5), the angle formed by an interior wall of the reaction chamber and an injection direction may range from 5 to 90 degrees. The corresponding angle of intersection formed by two impinging streams of oxygen are indicated in the table. The table also indicates the approximate intersection distance of the two streams, the intersection distance being the distance separating a point of intersection of the two streams if the streams impinged one another head-on (forming a 1809 angle) and the actual point of intersection of the two streams.

According to some embodiments, the orientation of orifices relative to the longitudinal axis of the reaction chamber is not fixed, and may be adjusted during operation, for example by using pivotable injectors.

According to some embodiments of the disclosure, instead injecting only an oxidant into the flowing feedstock, pulsed torches or injectors may be used to inject streams of a fuel-oxidant mixture directly into the reaction chamber. By sufficiently pre-heating the feedstock, the fuel-oxidant mixture may auto-ignite upon mixing with the feedstock. The heat of combustion may therefore be more efficiently transferred to the feedstock than if the fuel-oxidant mixture had been combusted in off-board combustors.

According to some embodiments of the disclosure, a method of decomposing a pre-heated feedstock includes flowing a stream of the pre-heated feedstock and injecting a fuel and an oxidant into the flowing stream such that the fuel and the oxidant mix with the pre-heated feedstock. In response to the fuel mixing with the pre-heated feedstock in the presence of the oxidant, the fuel auto-ignites and generates one or more combustion products that mix with the pre-heated feedstock and cause the pre-heated feedstock to decompose into one or more reaction products.

According to some embodiments, instead of continuously flowing the feedstock along a reaction chamber, the pre-heated feedstock may be loaded into a reaction chamber that is designed to be sealed. After sealing, the fuel and the oxidant may be injected into the sealed chamber such that the fuel and the oxidant mix with the pre-heated feedstock to drive decomposition of the feedstock as described above.

As described above, prior to being flowed along the reaction chamber, the feedstock may be pre-heated (for example, by using a heat-exchanger or some other heater) to a temperature sufficient such that the fuel, when brought into contact with the pre-heated feedstock, will auto-ignite in the presence of the oxidant. This may avoid the need to use spark plugs or other igniters to trigger the combustion. The specific temperature required for auto-ignition will depend on the nature of the feedstock and the fuel. For example, according to some embodiments, the feedstock may comprise methane, the oxidant may be air, and the temperature required for auto-ignition of the feedstock may be at least 850 K (at 1 bar). According to some embodiments, the feedstock may comprise hydrogen, the oxidant may be air, and the temperature required for auto-ignition of the feedstock may be at least 770 K (at 1 bar). According to some embodiments, the feedstock may comprise carbon monoxide, the oxidant may be air, and the temperature required for auto-ignition of the feedstock may be at least 880 K (at 1 bar).

The fuel and the oxidant may be either mixed before entering the reaction chamber or upon entering the reaction chamber. For example, according to some embodiments, fuel and oxidant valves on the injectors may open to allow the fuel and the oxidant to enter the injector to mix within the injector using any suitable mixing strategies, such as jet-in crossflow mixing. The fuel-oxidant mixture (or “premix”) may then be injected under pressure into the reaction chamber, and may then be ignited by the hot feedstock, generating combustion products that transfer their energy to the feedstock, resulting in decomposition of the feedstock.

According to some embodiments, instead of being mixed within the injectors, and the fuel and the oxidant may mix together upon entering the reaction chamber. In this case, the intent is for the fuel and oxidant to mix as the gases leave the injector, thereby ensuring that combustion doesn't occur in the injector to avoid the injector burning out.

During pyrolysis of the feedstock, thermal energy is transferred from the combustion products to the feedstock. In the case of a sealed reaction chamber, energy may also be transferred from the hot combustion products to the feedstock via dynamic compression of the feedstock as a result of the pressure increasing within the reaction chamber in response to the generation of combustion products within the reaction chamber. Past a certain point, the increase in the temperature of the feedstock is sufficient to drive decomposition or pyrolysis of the feedstock. In the case of methane, for example, the decomposition takes the following form:

CH₄+energy→C+2H₂

The reaction products that are produced by the pyrolysis may then be extracted from the reaction chamber, for example by opening an outlet valve.

According to some embodiments, a portion of the reaction products may be recycled back to the reaction chamber for future reaction cycles. In the case of methane pyrolysis, the reaction products comprise one or more of hydrogen, nitrogen, and carbon, the unwanted products are primarily carbon dioxide, nitrogen, and water, and the recycled gas mixture comprises primarily unreacted natural gas, hydrogen, nitrogen, and carbon monoxide. Non-decomposed feedstock that has been recycled may therefore be used as the fuel that is provided to the injectors.

According to some embodiments, instead of relying on some of the feedstock itself to drive the combustion, the fuel may have a composition that is different to the feedstock. This may increase the overall amount of feedstock that can be decomposed. For example, other potential fuels that may be used include hydrogen, one or more exhaust gases from a pressure swing adsorption unit, or a blend of these gases. The exhaust gases may include one or any combination of natural gas, CO, and CO₂. The pressure swing adsorption unit may be a unit that is used to separate hydrogen from the product stream that is extracted from the reaction chamber following pyrolysis.

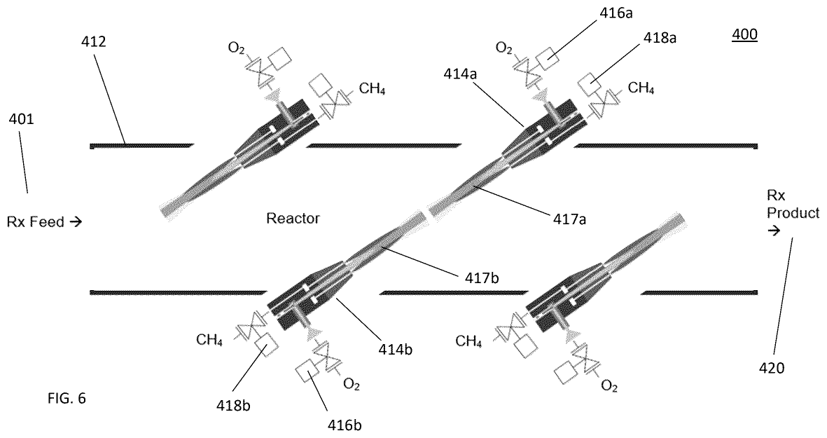

Turning to FIG. 6, there is shown a schematic diagram of a feedstock reactor being used to decompose a pre-heated feedstock, according to an embodiment of the disclosure.

FIG. 6 shows a reaction chamber 412 with a feedstock inlet 410 at one end and a reaction product outlet 420 at the opposite end. Four injectors are shown (only two of which are labelled). Each injector 414 includes an oxidant valve 416 and a fuel valve 418. The embodiment shown in FIG. 6 is a steady-flow design in which feedstock is continuously flowed along reaction chamber 412. According to some embodiments, instead of using a steady-flow design, a constant-pressure design may be used instead and in which, as described above, the injectors may be configured to inject the fuel and oxidant into a sealed chamber containing the pre-heated feedstock.

As can be seen in FIG. 6, a flame front 417 is emitted out of the end of each injector nozzle as the fuel and oxidant are injected into reaction chamber 2 containing the pre-heated feedstock. Injectors 414 may be oriented such that the flame front of one injector (e.g., flame front 417a of injector 414a) intersects the flame front of another injector (e.g., flame front 417b of injector 414b). This may improve mixing of the fuel and oxidant, that are emitted by injectors 414a, 414b, with the pre-heated feedstock.

In the embodiment of FIG. 6, the oxidant and fuel flow through different channels within each injector 414 and therefore do not mix until they exit injectors 414 and enter reaction chamber 412.

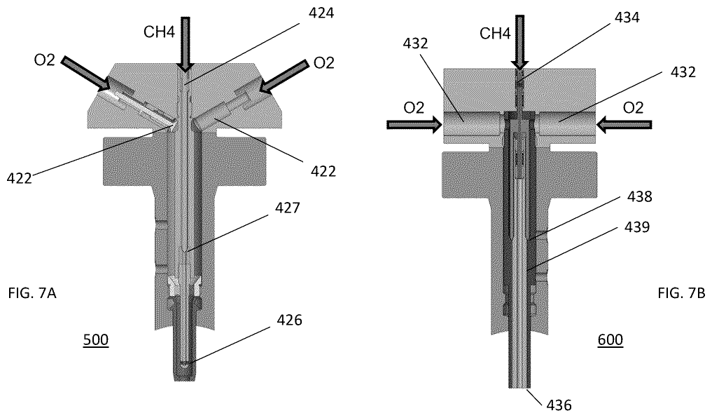

Turning to FIGS. 7A and 7B, there are shown schematic diagrams of injectors 500, 600 that may be used to deliver a fuel and an oxidant to a reaction chamber containing a pre-heated feedstock, according to an embodiment of the disclosure.

As can be seen in each of FIGS. 7A and 7B, each injector 500, 600 includes oxidant valves 422, 432 (e.g., O₂ valves) and a fuel valve 424, 434 (e.g., a methane valve). Unlike the embodiment of FIG. 6, in the embodiment of FIG. 7A, the oxidant and fuel are mixed within injector 420, and the mixture is emitted out of nozzle 426 at the end of injector 420. In particular, fuel valve 424 comprises a needle that seals on a seat 427, and the fuel and oxidant mix in the bottom of nozzle 426. In the embodiment of FIG. 7B, fuel flows down the centerline of part 434 which also lifts to control the flow of oxidant across a seat 438. The oxidant flows in an annular volume 439. The fuel and oxidant mix as they exit nozzle 436, similarly to the embodiment of FIG. 6.

The injectors may be designed such that they extend partway into the interior of the reaction chamber. As a result, the flame that is produced as the fuel-oxidant mixture exits the nozzle, or as the un-mixed fuel and oxidant exit the nozzle, may be entirely contained within the reaction chamber. As such, the combustion energy that is produced is generally contained within the reaction chamber, and minimal heat may be transferred to the interior walls of the reaction chamber. Furthermore, by avoiding the flow of hot combustion products through the nozzle itself, the nozzle may undergo less erosion than in the case of the combustion occurring in off-board combustors.

According to some embodiments, the injection of oxidant (or a combination of oxidant and fuel) into the flowing stream of feedstock may be intermittent or pulsed such that the local auto-ignition of surrounding fuel/feedstock creates corresponding transient pulses in local temperature and pressure. Pressure pulses may generate rapid fluctuations in mass flow rate in the reactor, which can help to clear carbon fouling or unwanted carbon accumulation. To optimize the characteristics of the pressure and flow rate pulses for the purpose of reactor de-fouling, a downstream pressure drop may be introduced to ensure peak pressures and maximum flow rates are suited to serve the cleaning function while not becoming unfavorable from the perspective of material and/or performance degradation. Such a pressure drop can be imposed by an orifice restriction, tuned piping systems, a control valve, or the like.

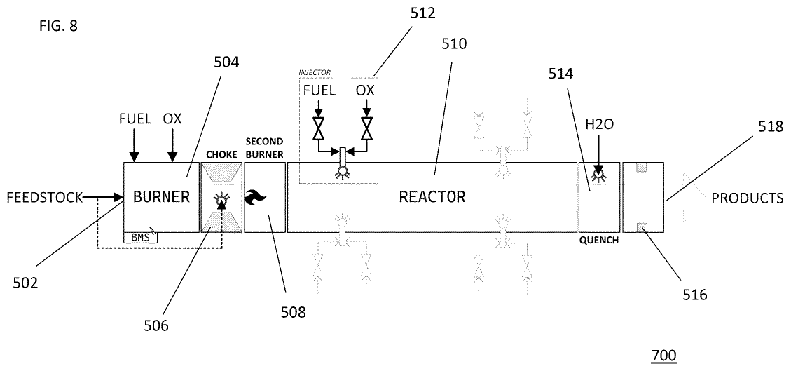

As described above, the oxidant (or oxidant and fuel) injectors described herein may be used in a steady-flow reactor. A further example of such a reactor is shown schematically in FIG. 8.

As can be seen in FIG. 8, a steady-flow reactor 800 is configured such that a pre-heated feedstock gas is continuously flowed under pressure along reactor 800, from an inlet 502 to an outlet 518. Reactor 800 includes a burner 502 at an upstream end thereof. A fuel and an oxidant (such as pure oxygen or air) are delivered to burner 504 which generates combustion products from the fuel-oxidant mixture. For example, a burner management system may have an ignitor to trigger combustion of the fuel-oxidant mixture so auto-ignition temperatures are not required to start the flame. The fuel may be feedstock or any combustible mixture (e.g., recycled syngas).

According to some embodiments, the burner may use a trapped vortex mixer as described in Patent Cooperation Treaty Publication No. WO2024124325, filed Sep. 28, 2023, the contents of which is hereby incorporated by reference in its entirety.

The combustion products pass through a choke 506 which constricts the flow passage and acts as a nozzle to accelerate the flow of combustion products into a reaction chamber or zone 510. According to some embodiments, instead of or in addition to entering reactor 800 at inlet 502, feedstock may also be delivered radially to the longitudinal axis of reactor 800 at choke 506. By increasing the fluid speed, choke 506 may improve mixing of the combustion products with the feedstock. Depending on the stoichiometry of the fuel-oxidant mixture, secondary combustion (“second burner”) may take place immediately downstream of choke 506, in mixing zone 508, as the oxidant-rich mixture mixes with feedstock injected in choke 506.

After exiting choke 506, the combustion products mix with the feedstock in a mixing zone 508 immediately downstream of choke 506. As described above, mixing of the combustion products with the pre-heated feedstock drives pyrolysis of the feedstock. The decomposition continues until the flow of feedstock reaches a quench 514 at which the reaction is stopped, for example by introducing water or some other coolant to the feedstock, or by depressurizing the reaction. The reaction products are extracted at the downstream end of reactor 800.

The specific reaction products that are produced are a function of the “residence time” which is the average duration of time that the feedstock and combustion product mixture spends in reaction zone 510 (which includes mixing zone 508) extending between choke 506 and quench 514. The residence time depends in particular on the rate of flow of feedstock along reactor 800 and the length of reaction zone 510.

Optionally, one or more fuel-oxidant injectors 512 are provided along the length of reaction zone 510. Each injector 512 (which may be any of the injectors described herein) is configured to inject a fuel-oxidant mixture through a nozzle that sprays the mixture into reaction zone 510. The mixture combusts in response to mixing with the pre-heated feedstock. The combustion generates further combustion products that further drive pyrolysis of the feedstock.

According to some embodiments, instead of using fuel-oxidant injectors 512, the injectors may be configured to inject only an oxidant into reaction zone 510, as also described herein.

According to some embodiments, back-pressure control 516 may be used to maintain an elevated reactor pressure, enabling pulsed pressure via pulsed injection. Such control may be achieved using a valve, orifice, pipe section, or flow constriction, for example.

In all embodiments described herein, operation of the reactor's various valves may be controlled by a suitable controller (such as a microprocessor) comprising circuitry. The controller (not shown), or some other controller, may control the flow of feedstock, oxidant, and/or fuel into the reaction chamber by controlling valves and compressors or similar devices, for example.

The word “a” or “an” when used in conjunction with the term “comprising” or “including” in the claims and/or the specification may mean “one”, but it is also consistent with the meaning of “one or more”, “at least one”, and “one or more than one” unless the content clearly dictates otherwise. Similarly, the word “another” may mean at least a second or more unless the content clearly dictates otherwise.

The terms “coupled”, “coupling” or “connected” as used herein can have several different meanings depending on the context in which these terms are used. For example, as used herein, the terms coupled, coupling, or connected can indicate that two elements or devices are directly connected to one another or connected to one another through one or more intermediate elements or devices via a mechanical element depending on the particular context. The term “and/or” herein when used in association with a list of items means any one or more of the items comprising that list.

As used herein, a reference to “about” or “approximately” a number or to being “substantially” equal to a number means being within +/−10% of that number.

Use of language such as “at least one of X, Y, and Z,” “at least one of X, Y, or Z,” “at least one or more of X, Y, and Z,” “at least one or more of X, Y, and/or Z,” or “at least one of X, Y, and/or Z,” is intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

While the disclosure has been described in connection with specific embodiments, it is to be understood that the disclosure is not limited to these embodiments, and that alterations, modifications, and variations of these embodiments may be carried out by the skilled person without departing from the scope of the disclosure.

It is furthermore contemplated that any part of any aspect or embodiment discussed in this specification can be implemented or combined with any part of any other aspect or embodiment discussed in this specification.

1. A method of decomposing a pre-heated feedstock, comprising:
flowing a stream of the pre-heated feedstock;
injecting an oxidant into the flowing stream of pre-heated feedstock,
wherein the oxidant mixes with the pre-heated feedstock and wherein, in response to the mixing, at least a first portion of the pre-heated feedstock auto-ignites and causes at least a second portion of the pre-heated feedstock to decompose into one or more products by pyrolysis.

2. The method of claim 1, wherein flowing the stream of the pre-heated feedstock comprises:
pre-heating a feedstock to within a range of 500 degrees C. to 1,125 degrees C.; and
flowing the stream of the pre-heated feedstock.

3. The method of claim 1, wherein injecting the oxidant comprises injecting the oxidant into the flowing stream of pre-heated feedstock through one or more nozzles.

4. The method of claim 3, wherein:
flowing the stream of the pre-heated feedstock comprises flowing the stream of the pre-heated feedstock along a conduit; and
the nozzles extend through one or more walls of the conduit.

5. The method of claim 1, wherein mixing the oxidant with the pre-heated feedstock comprises:
injecting a first stream of the oxidant into the flowing stream of pre-heated feedstock; and
injecting a second stream of the oxidant into the flowing stream of pre-heated feedstock, wherein the first and second streams intersect to improve mixing of the oxidant with the pre-heated feedstock.

6. The method of claim 5, wherein:
injecting the first stream of the oxidant comprises injecting the first stream from a first fluid injector;
injecting the second stream of the oxidant comprises injecting the second stream from a second fluid injector; and
the method further comprises:
injecting from the first fluid injector a third stream of the oxidant; and
injecting from the second fluid injector a fourth stream of the oxidant that intersects with third stream to improve mixing of the oxidant with the pre-heated feedstock.

7. The method of claim 6, further comprising:
injecting from the first fluid injector a fifth stream of the oxidant; and
injecting from the second fluid injector a sixth stream of the oxidant that intersects with the fifth stream to improve mixing of the oxidant with the pre-heated feedstock.

8. The method of claim 5, further comprising:
injecting a third stream of the oxidant into the flowing stream of pre-heated feedstock; and
injecting a fourth stream of the oxidant into the flowing stream of pre-heated feedstock that intersects with the third stream and generates within the flowing stream of pre-heated feedstock a further stream of the oxidant that intersects with a stream of the oxidant generated as a result of the first stream intersecting with the second stream.

9. The method of claim 5, wherein
injecting the first stream of the oxidant comprises injecting the first stream from a first fluid injector; and
injecting the second stream of the oxidant comprises injecting the second stream from a second fluid injector offset from the first fluid injector, wherein, in response to the first and second streams intersecting one another, vorticity is introduced to at least one of the first and second streams to improve mixing of the oxidant with the pre-heated feedstock.

10. The method of claim 1, wherein the pre-heated feedstock comprises a hydrocarbon.

11. The method of claim 10, wherein the hydrocarbon is methane or natural gas.

12. The method of claim 1, wherein the oxidant comprises pure oxygen.

13. The method of claim 1, wherein injecting the oxidant comprises pulsing the injection of the oxidant into the flowing stream of pre-heated feedstock.

14. The method of claim 13, further comprising using a flow restriction downstream of a location at which the oxidant is injected in order to control a pressure pulse generated by the pulsing of the oxidant injection.

15. The method of claim 1, wherein injecting the oxidant into the flowing stream of pre-heated feedstock comprises:
injecting a fuel with the oxidant into the flowing stream of pre-heated feedstock,
wherein, in response to the fuel mixing with the pre-heated feedstock in the presence of the oxidant, the fuel auto-ignites and generates one or more combustion products that mix with the pre-heated feedstock and cause the pre-heated feedstock to decompose into one or more reaction products.

16. The method of claim 15, wherein injecting the fuel and the oxidant comprises:
mixing the fuel with the oxidant to form a combustible mixture; and
injecting the combustible mixture into the flowing stream of pre-heated feedstock.

17. The method of claim 15, wherein injecting the fuel and the oxidant comprises simultaneously injecting the fuel and the oxidant into the flowing stream of pre-heated feedstock.

18. The method of claim 17, wherein simultaneously injecting the fuel and the oxidant into the flowing stream of pre-heated feedstock results in the fuel and oxidant mixing together in the flowing stream of pre-heated feedstock.

19. The method of claim 15, wherein the fuel has a composition that is different to the composition of the feedstock.

20. The method of claim 19, wherein the fuel comprises one or any combination of: hydrogen; CO; CO₂; and a hydrocarbon.

21. The method of claim 15, wherein injecting the fuel and the oxidant comprises:
injecting the fuel and the oxidant through a nozzle that extends into a reaction chamber along which the stream of pre-heated feedstock is flowing.

22. The method of claim 1, further comprising:
combusting a fuel and an oxidant in a burner located upstream of a location where the oxidant is injected into the flowing stream of pre-heated feedstock, thereby producing combustion products; and
mixing the combustion products with the flowing stream of pre-heated feedstock to drive decomposition of the pre-heated feedstock by pyrolysis.

23. The method of claim 22, wherein:
flowing the stream of pre-heated feedstock comprises flowing the stream of pre-heated feedstock through a choke; and
the method further comprises flowing the combustion products through the choke.

24. The method of claim 23, wherein flowing the stream of pre-heated feedstock comprises flowing the pre-heated feedstock into the choke in a first direction after which the stream of pre-heated feedstock flows out of the choke in a second direction perpendicular to the first direction.

25. The method of claim 22, wherein:
the fuel and the oxidant are provided to the burner in a lean fuel-oxidant mixture such that residual oxidant mixes with the pre-heated feedstock and causes some of the pre-heated feedstock to auto-ignite and generate further combustion products.

26. The method of claim 22, further comprising quenching the decomposition of the pre-heated feedstock at a location downstream of where the oxidant is injected into the flowing feedstock.

27. The method of claim 1, wherein the method uses a steady-flow reactor.

28. A feedstock reactor comprising:
a reaction zone;
valving and one or more compressors for allowing a pre-heated feedstock to flow along the reaction zone, and for allowing an oxidant to flow into the reaction zone; and
one or more controllers comprising circuitry and configured to:
control the valving and the one or more compressors to flow a stream of the pre-heated feedstock along the reaction zone; and
control the valving and the one or more compressors to inject an oxidant into the flowing stream of pre-heated feedstock, wherein the oxidant mixes with the pre-heated feedstock, and wherein, in response to the mixing, at least a first portion of the pre-heated feedstock auto-ignites causes at least a second portion of the pre-heated feedstock to decompose into one or more products.

29. The feedstock reactor of claim 28, wherein:
the valving and the one or more compressors are further configured to allow a fuel to flow into the reaction zone; and
the one or more controllers are further configured to:
control the valving and the one or more compressors, when with the pre-heated feedstock is flowing along the reaction zone, to inject the fuel and the oxidant into the reaction zone such that the fuel and the oxidant mix with the pre-heated feedstock,
wherein, in response to the fuel mixing with the pre-heated feedstock in the presence of the oxidant, the fuel auto-ignites and generates one or more combustion products that mix with the pre-heated feedstock and cause the pre-heated feedstock to decompose into one or more reaction products.
